(19) United States
(12) Patent Application Publication
(10) Pub. No.: US 2019/0258825 A1
(43) Pub. Date: Aug. 22, 2019

(54) System and Method for Data Masking and Managing Communications

(71) Applicant: EXOTEL TECHCOM PVT. LTD., Bangalore (IN)

(72) Inventor: Karthikeyan Krishnamurthy, Bangalore (IN)

(21) Appl. No.: 16/278,794

(22) Filed: Feb. 19, 2019

(30) Foreign Application Priority Data
Feb. 20, 2018 (IN) 2018 41002388
Feb. 19, 2019 (IN) 201841002388

(51) Int. Cl. G06F 21/62; H04L 29/06; H04M 3/51; H04M 3/20

(52) U.S. Cl. CPC G06F 21/6254; H04M 3/205; H04M 3/5183; H04L 63/0428

(57) ABSTRACT

Exemplary embodiments of the present disclosure are directed towards a system for masking original data and managing communications. The system comprising a first communication management module configured to receive communication requests associated with a plurality of identities from communication devices, said first communication management module is configured to send said plurality of identities to a second communication management module and a database is configured to store said plurality of identities by said second communication management module, said second communication management module is configured to search said plurality of identities from said database and retrieve the data associated with said plurality of identities, said second communication management module is configured to mask said retrieved data by a virtual data and said first communication management module and said second communication management module are configured to display said virtual data.

### RELATED APPLICATION AND PRIORITY CLAIM

The present disclosure claims priority from co-pending India Provisional Patent Application having the title “SYSTEM AND METHOD FOR DATA MASKING AND MANAGING COMMUNICATIONS”, assigned Application Number: 201841002388, Filed on: 20 Feb. 2018 and co-pending India non-Provisional Application having the title “SYSTEM AND METHOD FOR DATA MASKING AND MANAGING COMMUNICATIONS”, assigned Application Number: 201841002388, Filed on: 19 Feb. 2019, both the co-pending applications being incorporated in their entirety into the present application, to the extent not inconsistent with the disclosure herein.

### TECHNICAL FIELD

The disclosed subject matter relates generally to the field of data communications. More particularly, the present disclosure relates to a system and method for masking an original data by a virtual data and managing communications between communication devices.

### BACKGROUND

Privacy is the important concern in establishing or managing communications between individuals. Therefore, many individuals try to protect their privacy as much as possible and moreover do not want their telephone numbers to be known or revealed. For instance the individuals here may be categorized as users, agents, and organizers. The user includes a customer, a client, a consumer, a cab rider requesting a service. The agent includes a cab driver, a service provider, a service agent, an employee, company personnel, etc. If the agent (for e.g., cab driver) wishes to call the user (for e.g., the rider), the agent has to click on a button on a service module and then the service module opens up the rider details. There is a chance of misusing the user's data by the agent. The user's data comprises a name, a mail identity, a phone number, a personal address, an IP address, a passport number, an order identity, etc. Since the user's data is visible on an agent's communication device, there is a chance of unauthorized access of user's data.

As the usage of internet is increasing, more and more individuals are accessing communications services via communication devices. Information technology services enable organizations to manage an individual's data for different purposes. The organizations are now able to share individual's data without being restricted by geographical boundaries. As a result of extensive sharing of individual's data both within and outside organizations for various purposes, data privacy has become a primary concern for handling individual's sensitive data. Further, there may be scenarios where the use of data masking solution is very minimal involving access by conventional methods for a limited period of time. In such a case, deployment of a standalone solution is a significant overhead for an organization.

In the light of the aforementioned discussion, there exists a need for a certain system with novel methodologies that would overcome the above-mentioned disadvantages.

### SUMMARY

An objective of the present disclosure is directed towards protecting user's original data or agent's original data by data masking.

Another objective of the present disclosure is directed towards recording the communications between the users and the agents for training or dispute resolution.

Another objective of the present disclosure is directed towards tracking the status of the conversations in real time.

Another objective of the present disclosure is directed towards implementing cost-effective measures.

Another objective of the present disclosure is directed towards reducing a delay in the communication process.

Another objective of the present disclosure is directed towards enabling data privacy and security for the users by ensuring that the users' personal data is not available to the agents.

Another objective of the present disclosure is directed towards improving service levels by analyzing the communication that happens between the agents and the users.

Another objective of the present disclosure is directed towards recording calls and analyzing the call recording to help with dispute resolution between the users and the agents, providing training to new agent, understanding key-words in the conversation and take preventive measures to avoid user dissatisfaction, and providing more such value-adds in the future.

Another objective of the present disclosure is directed towards analyzing call recordings using a combination of speech to text and audio fingerprinting techniques to provide insights.

Another objective of the present disclosure is directed towards understanding the status of the calls that happened (for example, missed-call, cancelled call, successful call) and duration of such calls.

Another objective of the present disclosure is directed towards finding out whether agent stick to the service level guarantees that have been promised to the user.

Another objective of the present disclosure is directed towards masking user's original data during communication thus ensuring user privacy and avoiding future misuse by the agent.

Another objective of the present disclosure is directed towards providing a dialer service to handle or intercept calls, a data processing service to manage the data, a call recorder service, an obfuscator which manages the call logs of the communication device, and a backend cloud service which stores all information for further processing.

In an embodiment of the present disclosure, a method comprising a step of receiving communication requests with identities to the agents from the users by a first communication management module.

In another embodiment of the present disclosure, the method comprising a step of sending the received identities to a second communication management module from the first communication management module.

In another embodiment of the present disclosure, the method comprising a step of accepting the identities by the second communication management module and storing it in a database.

In another embodiment of the present disclosure, the method comprising a step of search the received identities from the database and retrieve the data associated with the received identities by the second communication management module.

In another embodiment of the present disclosure, the method comprising a step of masking the retrieved data by the virtual data and display the virtual data on the second communication management module and the first communication management module.

In another embodiment of the present disclosure, the method comprising a step of establishing a communication between the agent and the user by the virtual data and record conversations for the established communication by the second communication management module. Store the recorded conversations in the database.

In another embodiment of the present disclosure, the method comprising a step of deleting or obfuscating the recorded conversations from the operating systems' communications history by the second communication management module.

In another embodiment of the present disclosure, the method further comprising a step of analyzing the recorded conversations and determining the status of the conversations by the second communication management module. Store the status of the conversations in the database.

In another embodiment of the present disclosure, the method further comprising a step of sending the analyzed conversations and the status of the conversations to a service organizer's communication device.

In another embodiment of the present disclosure, a system comprising communication devices configured to receive communication requests associated with a plurality of identities by a first communication management module, the first communication management module is configured to send the plurality of identities to the second communication management module.

In another embodiment of the present disclosure, the communication devices are communicated over a network (internet), the communication devices are connected to a public-switched telephone network (PSTN) via a gateway, the communication devices are configured to allow a plurality of users to communicate over the network (internet) and the PSTN seamlessly.

In another embodiment of the present disclosure, the system comprising a database is configured to store the plurality of identities by the second communication management module, the second communication management module is configured to search the plurality of identities from the database and retrieve the data associated with the plurality of identities, the second communication management module is configured to mask the retrieved data by a virtual data and the first and second communication management modules are configured to display the virtual data, the communication devices are configured to establish communication between a plurality of users and a plurality of agents by the virtual data and the communication devices are also configured to record conversations for the established communication by the second communication management module, the second communication management module is configured to analyze the recorded conversations, determine the status of the conversations, and send the analyzed conversations and the status of the conversations to the communication devices.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram representing an example environment in which aspects of the present disclosure can be implemented. Specifically, FIG. 1 depicts a schematic representation of a system for masking data and managing communications between communication devices according to an embodiment of the present disclosure.

FIG. 2 is a block diagram depicting the first communication management module 108 and the second communication management module 110 shown in FIG. 1, in accordance with one or more embodiments.

FIG. 3A is an example diagram depicting a digital page of the second communication management module 110, in one or more exemplary embodiments.

FIG. 3B is an example diagram depicting a digital page of the first communication management module 108, in one or more exemplary embodiments.

FIG. 3C is an example diagram depicting the digital pages of the first communication management module 108 and the second communication management module 110, in one or more exemplary embodiments.

FIG. 3D is an example diagram depicting a call history page, in one or more exemplary embodiments.

FIG. 4 is a flow diagram depicting a method for masking the original data by the virtual data and managing communications between communication devices, in one or more exemplary embodiments.

FIG. 5 is an example flow diagram depicting a method for handling outbound conversations, in one or more exemplary embodiments.

FIG. 6 is an example flow diagram depicting a method for handling inbound conversations, in one or more exemplary embodiments.

FIG. 7 is a block diagram illustrating the details of digital processing system 700 in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

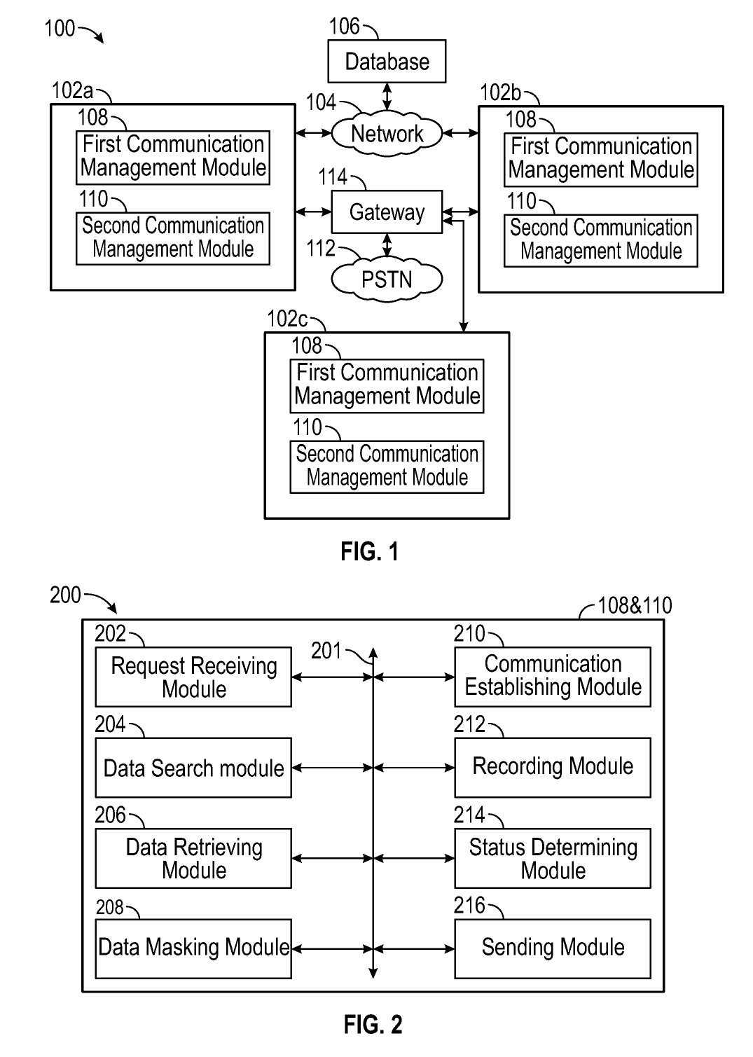

Referring to FIG. 1, FIG. 1 is a block diagram 100 representing an example environment in which aspects of the present disclosure can be implemented. Specifically, FIG. 1 depicts a schematic representation of environment for masking data and managing communications between communication devices according to an embodiment of the present disclosure. The environment 100 is providing the data on demand to a requesting user or a requesting agent in a masked or unmasked form. The environment 100 for providing privacy and security by masking certain data, used when communication happens between the agents and the users. The example environment is shown containing only representative devices and systems for illustration. However, real-world environments may contain more or fewer systems or devices. FIG. 1 depicts communication devices 102a, 102b, and 102c, a network 104, and a database 106. The communication devices 102a, 102b, and 102c comprise a user's communication device, an agent's communication device, and an organizer's communication device. The communication devices 102a, 102b, and 102c may comprise a device such as a personal computer, a workstation, an electronic book reader, a personal digital assistant, a mobile station, a mobile phone, a computing tablet, and the like. The network 104 may include, but is not limited to, an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service. The network 104 may provide a web interface employing transmission control protocol, hypertext transfer protocol, simple object access protocol or any other internet communication protocol. The database 106 is configured to store the user's data, and an agent's data. The agent's data comprises a name of an agent, a phone number, a mail identity, a unique identity, a social security number, a passport number, a license number, a URL, and the like. The communication devices 102a, 102b, and 102c are communicated over the network 104. The communication devices 102a, 102b, and 102c are preferably configured to accept a subscriber identity module card (not shown). The communication devices 102a, 102b, and 102c are identified by the combination of subscriber identity card identifier, international mobile equipment identifier, and a phone number. The subscriber identity module card (not shown) controls the ability of the communication devices 102a, 102b, and 102c to place or receive calls. The subscriber identity module card (not shown) may include, but not limited to, a physical SIM card, a virtual SIM card, and the like. The communication devices 102a, 102b, and 102c are connected to a public-switched telephone network (PSTN) 112 via a gateway 114, the communication devices 102a, 102b, and 102c are configured to allow the users to communicate over both networks 104, 112 (for example, internet and PSTN) seamlessly. The gateway 114 may include, but not limited to, a voice over internet protocol gateway, packet data network gateway, and the like. The network (for example, internet) 104 may be provided by the PSTN 112.

In one or more exemplary embodiments, a data masking architecture is shown, in which a first communication management module 108 and a second communication management module 110 are hosted by an agent or a user or an organizer on the communication devices 102a, 102b and 102c. The first communication management module 108 and the second communication management module 110 are accessed as mobile applications, web applications, software that offers the functionality of accessing mobile applications, and viewing/processing of interactive pages, for example, are implemented in the communication devices 102a, 102b, 102c as will be apparent to one skilled in the relevant arts by reading the disclosure provided herein. Example of the first communication management module 108, includes, but is not limited to, a customer service application, or a business application, which is configured to receive communication requests. The communication requests comprise the service requests, and process requests. Example of the second communication management module 110, includes, but is not limited to, a data masking application which is configured for managing communications. The managing communications comprises masking data, establishing communication between communication devices 102a and 102b, 102c recording conversations, analyzing recorded conversations, determining the status of the conversations, and sending the analyzed conversations and the status of the conversations. In another embodiment of the present disclosure, the communication devices 102a, 102b, and 102c are servers that deals in providing access to the first communication management module 108 and the second communication management module 110.

In one or more exemplary embodiments, the second communication management module 110 may be made as the default dialer application on the communication devices 102a, 102b, 102c on installation. When the agent or the user gets a communication request (for e.g., a service request) associated with identities by the first communication management module 108, then the first communication management module 108 sends the identities to the second communication management module 110. The identities comprise the user's data and the agent's data. The identities are stored in the database 106 by the second communication management module 110. The second communication management module 110 is configured to search the identities from the database 106 and retrieve the data associated with the identities. The second communication management module 110 is configured for masking the data by retrieving a virtual data from the database 106. The virtual data is associated with the identities. For an example, if the agent needs to call the user, then the agent has to select the call button on the first communication management module 110, and then the first communication management module 108 is configured to invoke the second communication management module 110 by passing on a unique identity. The second communication management module 110 receives the unique identity, performs the search using the unique identity through the database 106 and retrieve the data (for example, the user's data or agent's data) for the unique identity. The virtual data is used to mask the data retrieving from the database 106 on the first communication management module 108 and the second communication module 110. The second communication management module 110 is configured to subscribe to the updates from the first communication management module 108. The collected data is pushed into the database 106 by the second communication management module 110. For an example, when the user calls the agent, the call originates from the communication device 102a or 102b or 102c and travels through the PSTN 112 and land on the agent's number (based on the associated sim card (not shown)). The caller identity that is received by the agent's communication device 102a or 102b or 102c is what is set as part of the PSTN 112. The second communication management modules 110 intercepts the caller identity and changes the default data by masking or obfuscating it.

In one or more exemplary embodiments, the second communication management module 110 that controls the default dialer, SMS application or communication application in the communication devices 102a, 102b, 102c. The first communication management module 108 is configured to intimate the second communication management module 110 when a new communication request (for example, service request or order) is initiated. The second communication management module 110 is configured to intercept an incoming call from the user and mask the original caller identity (for example, CLI provided by the public switched telephone network) instead of displaying the relevant order identity. The second communication management module 110 has the ability to initiate the call to the user while masking the original caller identity and displaying the relevant order identity. The second communication management module 110 is also configured to delete or modify the call logs from the communication devices 102a, 102b, 102c. The database 106 is configured to store call recordings and fingerprint the audio files to find out the status of the calls (for example, completed call, missed call). Automatically process and store all the call related meta-data in the communication devices 102a, 102b, 102c and the cloud for consumption by the agent.

Communication is established between the agent and the user by the virtual data and conversations are recorded for established communication by the second communication management module 110. The recorded conversations are stored in the database 106 by the second communication management module 110. The conversations may include but are not limited to, telephone calls (for e.g., inbound calls, outbound calls), SMS text messages, e-mails, and the like. For an example, the second communication management module 110 can dial out the user phone number but does not display it on the communication devices 102a, 102b, 102c. Instead, it displays the virtual number (for e.g., name or unique identity). The virtual number is used to mask the user phone number by the second communication management module 110. The second communication management module 110 is configured to delete the conversations from the communication devices 102a, 102b and 102c default communication history. Then the second communication management module 110 is configured to analyze the communications and determine a status of the conversations. The status of the conversation may include, but is not limited to, type of call (for e.g., answered calls, blocked calls, unanswered calls, dropped calls, platform redirector errors, malformed call requests, platform component failures, caller hanging up), mail data (sent emails, received emails), and the like. For example, the status of the conversations is identified using a call state from the operating system of the communication device 102a, 102b and 102c, text-to-speech (TTS) service, and an audio fingerprinting service. The call recording is fed to the text-to-speech service and the output text may be analyzed. The output of the text-to-speech service is matched for key-words. The key-words for example, busy, not answering, switched-off, etc. the call recording is analyzed for its audio fingerprint against the database 106 of pre-recorded prompts. The prompts are the collection of network prompts of telephone operators. The recorded conversations and status of the conversations are sent to the communication device 102c (for example, organizer's communication device). Inbound conversations or outbound conversations (for e.g., inbound calls, outbound calls) are generated by the communication requests. The generated inbound conversations or outbound conversations are managed by the second communication management module 110. The communication devices 102a, 102b and 102c are configured to receive the inbound conversations associated with the identities by the first communication management module 108.

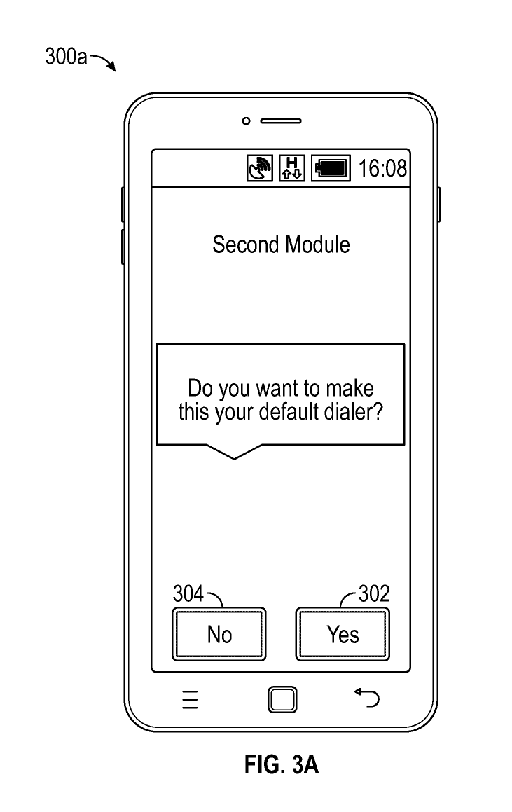

Referring to FIG. 2, FIG. 2 is a block diagram 200 depicting the first communication management module 108 and the second communication management module 110 shown in FIG. 1, in accordance with one or more embodiments. The first communication management module 108 and the second communication management module 110 comprises a bus 201, a requests receiving module 202, a data search module 204, a data retrieving module 206, a data masking module 208, a communication generating module 210, a recording module 212, a status determining module 214, and a sending module 216.

The database 106 is associated with the first communication management module 108 and the second communication management module 110. The request receiving module 202 is configured to receive communication requests associated with the identities of the users or the agents and the received identities are stored in the database 106. The data search module 204 is configured to search the data associated with the identities from the database 106. The data retrieving module 206 is configured to retrieve the data based on the performed search. The data masking module 208 is configured for masking the retrieved data by the virtual data. The communication devices 102a, 102b and 102c are configured to display the virtual data by the first communication management module 108 and the second communication management module 110. The communication establishing module 210 is configured to establish the communication between the users and the agents using the virtual data. The recording module 212 is configured to record the conversations for the established communication. The status determining module 214 is configured to determine the status of the conversations. The sending module 216 is configured to send the recorded conversations and the status of the conversations to the service organizer's communication device 102c. The bus 201 may include a path that permits communication among the modules of the first communication management module 108 and the second communication management module 110.

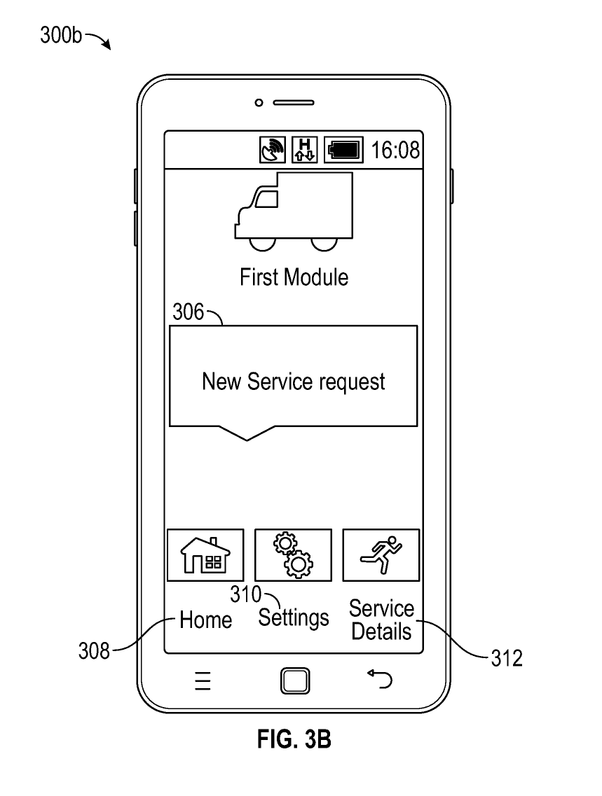

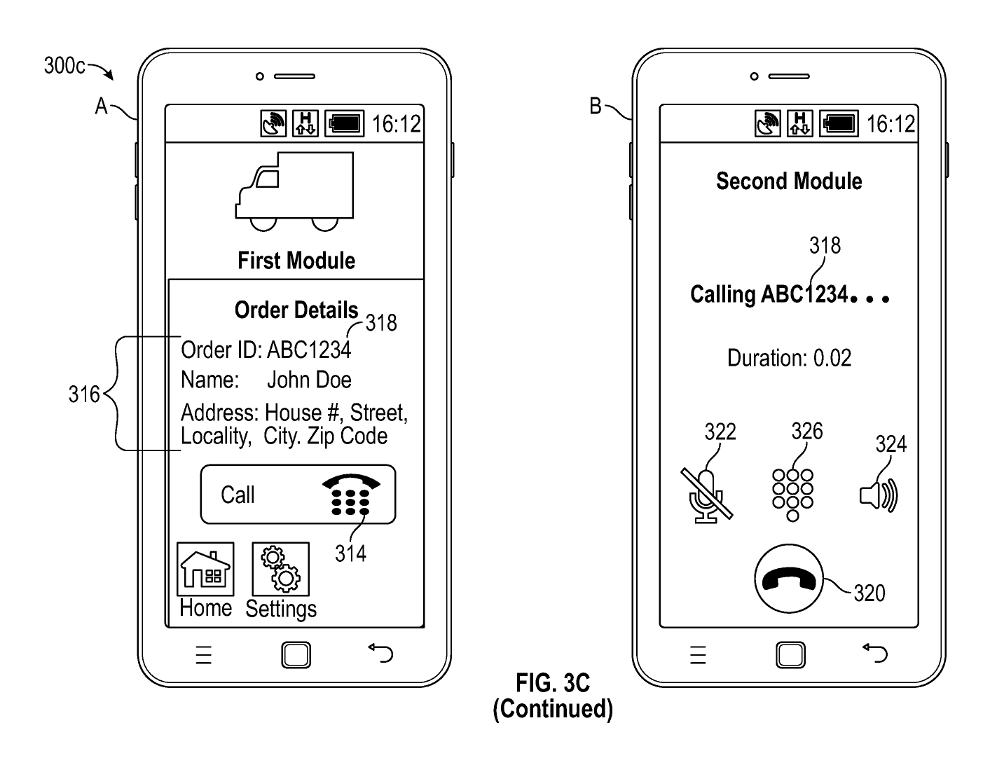

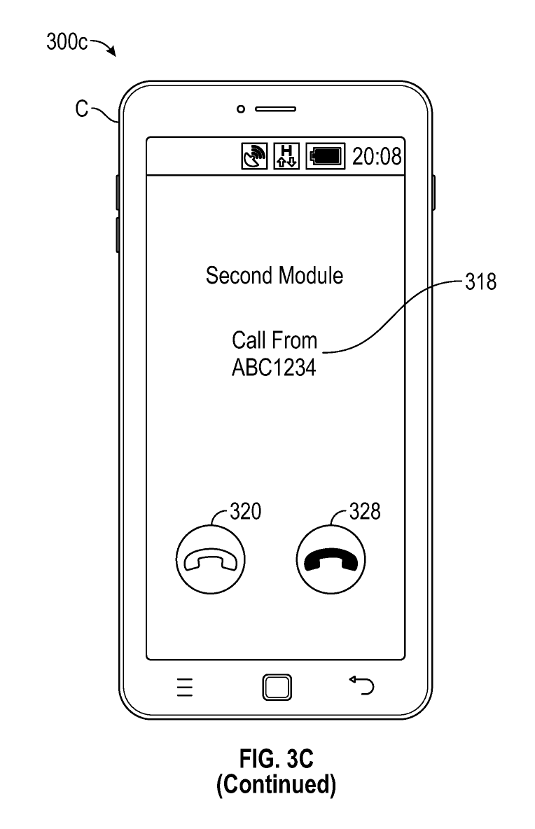

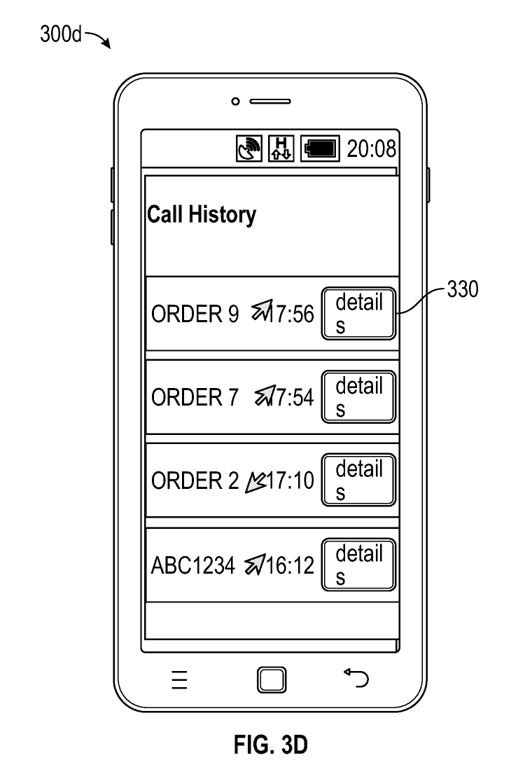

Referring to FIG. 3A, FIG. 3A is an example diagram 300a depicting a digital page of the second communication management module 110, in one or more exemplary embodiments. If the user or the agent installs the second communication management module 110 in the communication devices 102a, 102b and 102c, then the digital page 300a is displayed. The digital page 300a shows “do you want to make this your default dialer?” The digital page 300a comprises a YES icon 302, and a NO icon 304. If the user or the agent selects the YES icon 302, then it provides access to the first communication management module 108. If the user or agent selects the NO icon 304, then it intimates the first communication management module 108.

Referring to FIG. 3B, FIG. 3B is an example diagram 300b depicting a digital page of the first communication management module 108, in one or more exemplary embodiments. The digital page 300b comprises service request details 306, a home option 308, a settings option 310, and a service details option 312. The service request details 306 in the digital page of the first communication management module 108 are sent to the second communication management module 110. The home option 308 typically comprises icons associated with the first communication management module 108, as well as icons associated with the second communication management module 110. A number of additional user interfaces rendered on the digital page by the selection of settings option 312, it allows the user or agent to input data to the communication devices 102a, 102b and 102c. The service details option 312 is configured to provide the details of the service on the digital page 300b.

Referring to FIG. 3C, FIG. 3C is an example diagram 300 depicting the digital pages of the first communication management module 108 and the second communication management module 110, in one or more exemplary embodiments. The diagram 300c depicting the digital page A of the first communication management module 108, the digital page B of the second communication management module 110, and the digital page C of the second communication management module 110. The digital page A comprises a phone icon 314, and order details 316. The order details 316 depicts an order identity, a name, an address, and the like. The depicted details comprise the masked data by the second communication management module 110. To initiate a call, the user or agent selects the phone icon 314 on the digital page A by providing an input to the communication devices 102a, 102b and 102c. The input may include but is not limited to, an order identity. The digital page B of the second communication management module 110 is configured to dial out the user's number or the agent's number after selecting the phone icon 314 on the digital page A. The digital page B comprises an order identity 318, a cancel button 320, a mute button 322, a loudspeaker button 324, and a keypad icon 326. The order identity 318 may comprise the masked data. The cancel button 320, selection of which causes the communication devices 102a, 102b, and 102c to stop calling the user's number or the agent's number. If the mute button 322 has been activated, then the audio signal may not be enabled. However, if the mute button 322 has not been activated, then the audio signal may be enabled. An audio output signal is provided through the loudspeaker button 324. The keypad icon 326 is used to input a command for calling for a keypad onto the display. The keypad includes number keys and letter keys to input numbers or letters by the user or agent.

The digital page C comprises the order identity 318, the cancel button 320, and an accept button 328. The digital page B of the second communication management module 110 is configured to receive the call from the user's number or the agent's number. If the user or agent wants to answer the call, then the user or agent selects the accept button 328. However, if the user or agent is not interested to answer the call, then the user or agent selects the cancel button 320.

Referring to FIG. 3D, FIG. 3D is an example diagram 300d depicting a call history page, in one or more exemplary embodiments. The call history page 300d comprises details option 330, order numbers, and time. If the user or agent selects the details option 330, then it displays the receiving calls time with order identity or sending calls time with order identity.

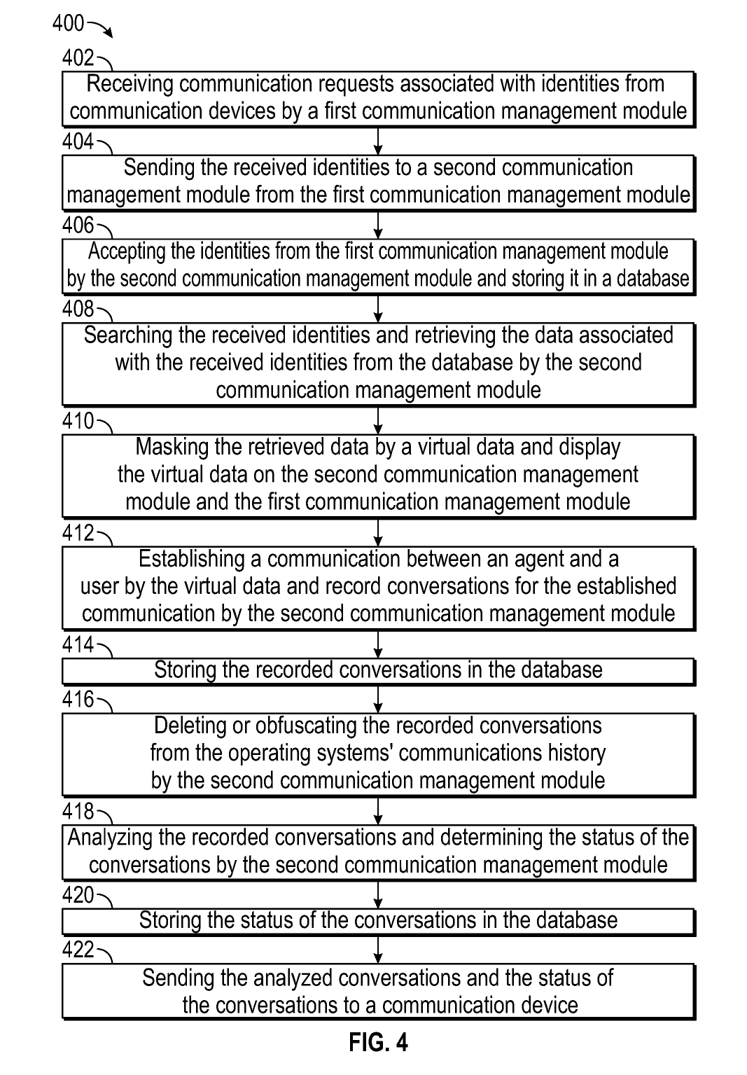

Referring to FIG. 4, FIG. 4 is a flow diagram 400 depicting a method for masking the retrieved data by the virtual data and managing the communications between the communication devices, in one or more exemplary embodiments. The method 400 may be carried out in the context of the details of FIG. 1, FIG. 2, and FIG. 3A-3D. However, the method 400 may also be carried out in any desired environment. Further, the aforementioned definitions may equally apply to the description below.

The method commences at step 402, receiving the communication requests associated with identities from the communication devices by the first communication management module. At step 404, sending the received identities to the second communication management module from the first communication management module. At step 406, accepting the identities from the first communication management module by the second communication management module and storing it in the database. At step 408, searching the received identities and retrieving the data associated with the received identities from the database by the second communication management module. At step 410, masking the retrieved data by the virtual data and display the virtual data on the second communication management module and the first communication management module. At step 412, establishing the communication between the agent and the user by the virtual data and record the conversations for the established communication by the second communication management module. Thereafter, at step 414, storing the recorded conversations in the database. Thereafter, at step 416, deleting or obfuscating the recorded conversations from the operating systems' communications history by the second communication management module. Thereafter, at step 418, analyzing the recorded conversations and determining the status of the conversations by the second communication management module. Thereafter, at step 420, storing the status of the conversations in the database. Thereafter, at step 422, sending the analyzed conversations and the status of the conversations to the communication device.

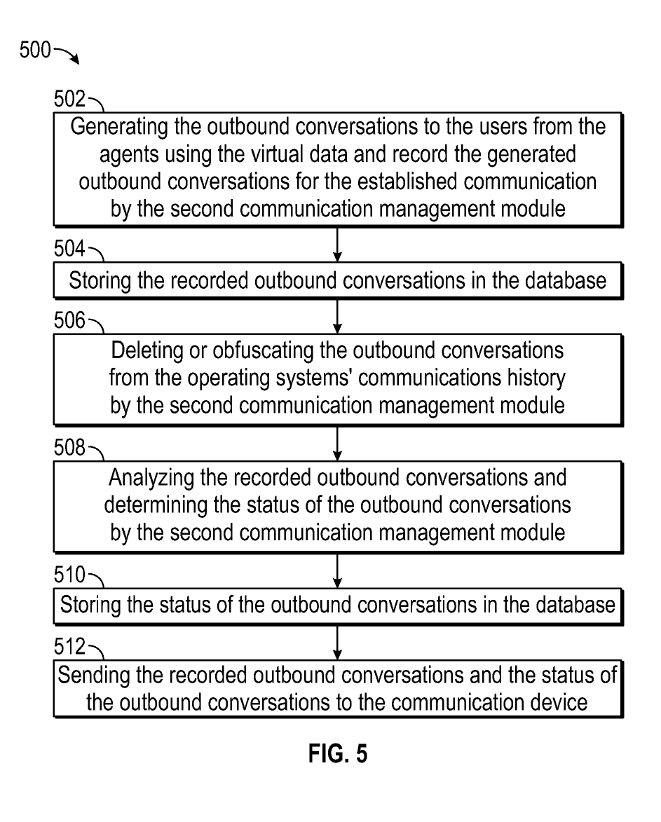

Referring to FIG. 5, FIG. 5 is an example flow diagram 500 depicting a method for handling outbound conversations, in one or more exemplary embodiments. The method 500 may be carried out in the context of the details of FIG. 1, FIG. 2, FIG. 3A-3D, and FIG. 4. However, the method 500 may also be carried out in any desired environment. Further, the aforementioned definitions may equally apply to the description below.

The method commences at step 502, generating the outbound conversations to the users from the agents using the virtual data and record the generated outbound conversations for the established communication by the second communication management module. Thereafter, at step 504, storing the recorded outbound conversations in the database. Thereafter, at step 506, deleting or obfuscating the outbound conversations from the operating systems' communications history by the second communication management module. Thereafter, at step 508, analyzing the recorded outbound conversations and determining the status of the outbound conversations by the second communication management module. At step 510, storing the status of the outbound conversations in the database. Thereafter, at step 512, sending the recorded outbound conversations and the status of the outbound conversations to the communication device, (for example, the organizer's communication device).

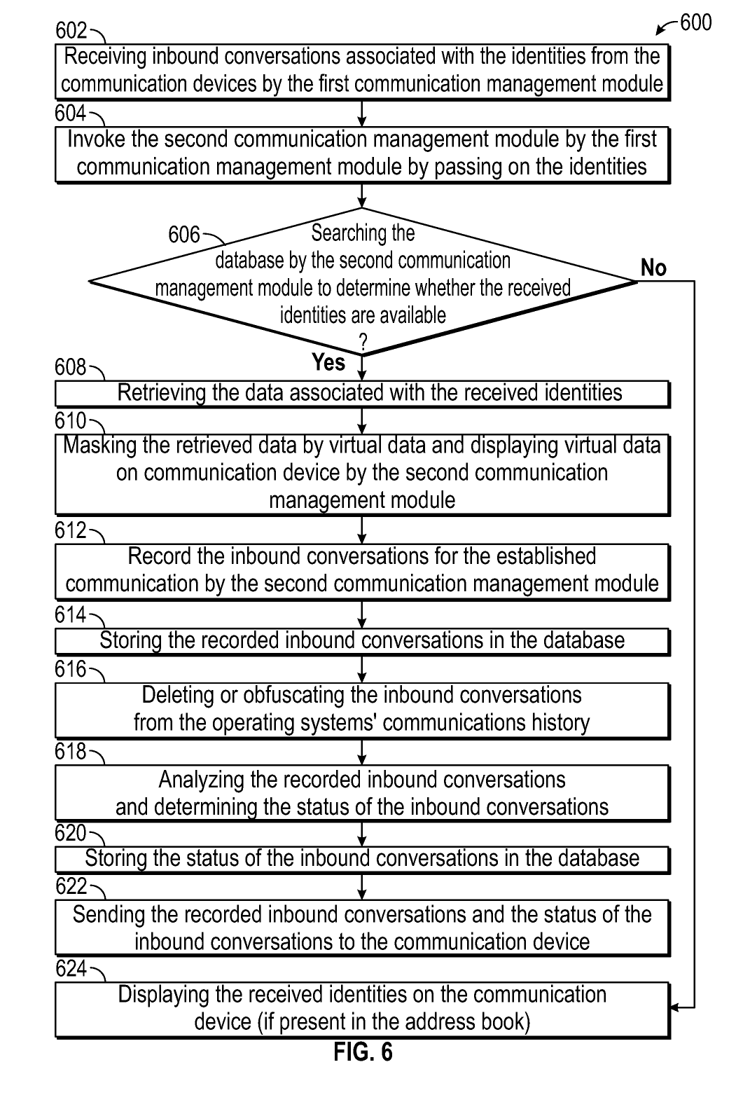

Referring to FIG. 6, FIG. 6 is an example flow diagram 600 depicting a method for handling inbound conversations, in one or more exemplary embodiments. The method 500 may be carried out in the context of the details of FIG. 1, FIG. 2, FIG. 3A-3D, and FIG. 4. However, the method 500 may also be carried out in any desired environment. Further, the aforementioned definitions may equally apply to the description below.

The method commences at step 602, receiving the inbound conversations associated with the identities from the communication devices by the first communication management module. At step 604, invoke the second communication management module by the first communication management module by passing on the identities. Thereafter, at step 606, searching the database by the second communication management module to determine whether the received identities are available. If the answer to step 606 is a YES, then at step 608, retrieving the data associated with the received identities. At step 610, masking the retrieved data by the virtual data and displaying the virtual data on the communication device by the second communication management module. Thereafter, at step 612, record the inbound conversations for the established communication by the second communication management module. Thereafter, at step 614, storing the recorded inbound conversations in the database. Thereafter, at step 616, deleting or obfuscating the inbound conversations from the operating systems' communications history. Thereafter, at step 618, analyzing the recorded inbound conversations and determining the status of the inbound conversations. At step 620, storing the status of the inbound conversations in the database. At step 622, sending the recorded inbound conversations and the status of the inbound conversations to the communication device (for example, the organizer's communication device). If answer to step 606 is a NO, then at step 624, displaying the received identities on the communication device (if present in the address book).

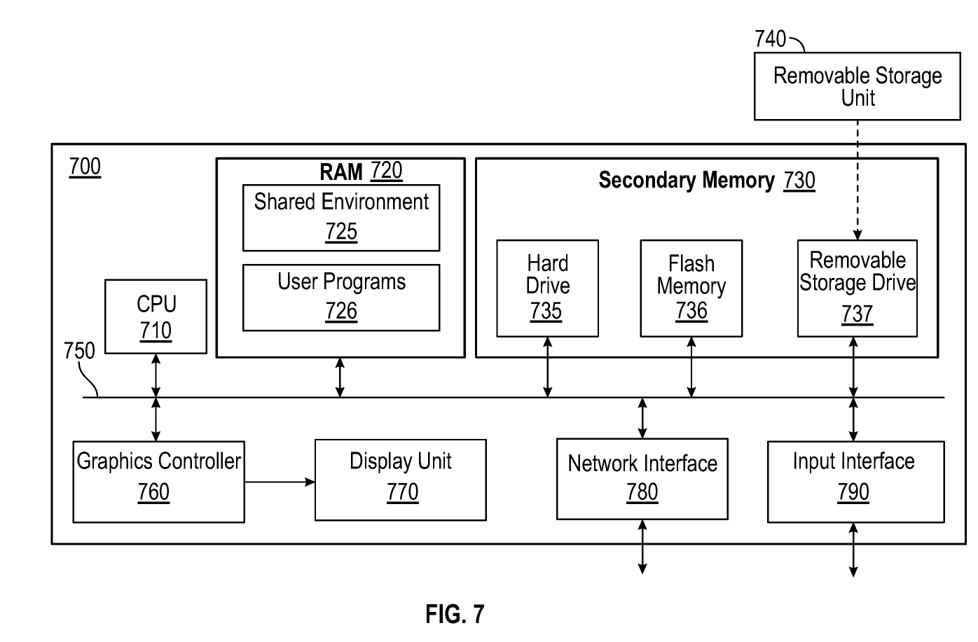

Referring to FIG. 7, FIG. 7 is a block diagram illustrating the details of digital processing system 700 in which various aspects of the present disclosure are operative by execution of appropriate software instructions. Digital processing system 700 may correspond to communication device 102a, 102b, and 102c (or any other system in which the various features disclosed above can be implemented).

Digital processing system 700 may contain one or more processors such as a central processing unit (CPU) 710, random access memory (RAM) 720, secondary memory 727, graphics controller 760, display unit 770, network interface 780, an input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1, network 104) connected to the network.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on the removable storage unit 740, and the data and instructions may be read and provided by removable storage drive 737 to CPU 710. Floppy drive, magnetic tape drive, CD-ROM drive, DVD Drive, Flash memory, a removable memory chip (PCMCIA Card, EEPROM) are examples of such removable storage drive 737.

The removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for masking an original data and managing communications, comprising:
a first communication management module is configured to receive communication requests associated with a plurality of identities from communication devices, whereby said first communication management module is configured to send said plurality of identities to a second communication management module, said communication devices are communicated over a network, said communication devices are connected to a public-switched telephone network (PSTN) via a gateway, said communication devices are configured to allow a plurality of users to communicate over said network and said PSTN seamlessly;
and
a database is configured to store said plurality of identities by said second communication management module, whereby said second communication management module is configured to search said database to retrieve the data associated with said plurality of identities, whereby said second communication management module is configured to mask said retrieved data by a virtual data and said first communication management module and second communication management module are configured to display said virtual data, said communication devices are configured to establish communication between the plurality of users and a plurality of agents by said virtual data and said communication devices are also configured to record conversations for said established communication by said second communication management module, whereby said second communication management module is configured to analyze said recorded conversations, determine the status of said conversations, and send said analyzed conversations and said status of said conversations to said communication devices.

2. The system of claim 1, wherein said communication devices are configured to generate outbound conversations using said virtual data and record said generated outbound conversations for said established communication by said second communication management module.

3. The system of claim 2, wherein said second communication management module is configured to obfuscate said outbound conversations from the operating systems' communication history.

4. The system of claim 2, wherein said second communication management module is configured to analyze said recorded outbound conversations and determine the status of said outbound conversations.

5. The system of claim 1, wherein said database is configured to store said recorded outbound conversations and store said status of said outbound conversations.

6. The system of claim 1, wherein said communication devices are configured to receive said inbound conversations associated with said plurality of identities by said first communication management module.

7. The system of claim 6, wherein said first communication management module is configured to invoke said second communication management module.

8. The system of claim 7, wherein said second communication management module is configured to search said database to retrieve the data associated with said plurality of identities.

9. The system of claim 7, wherein said second communication management module is configured to mask said retrieved data by said virtual data and record said inbound conversations for said established communication.

10. The system of claim 7, wherein said second communication management module is configured to analyze said recorded inbound conversations and determine the status of said inbound conversations.

11. The system of claim 1, wherein said database is configured to store said recorded inbound conversations and said status of said inbound conversations.

12. A method for masking an original data and managing communications, comprising:
receiving communication requests associated with a plurality of identities from communication devices by a first communication management module, whereby said first communication management module is configured to send said plurality of identities to a second communication management module;
storing said plurality of identities in a database by said second communication management module;
searching said plurality of identities from said database and retrieving the data associated with said plurality of identities by said second communication management module;
masking said retrieved data by a virtual data and displaying said virtual data on said second communication management module and said first communication management module;
establishing communication between a plurality of agents and a plurality of users by said virtual data and recording conversations for said established communication by said second communication management module;
analyzing said recorded conversations and determining said status of the conversations by said second communication management module; and
sending said analyzed conversations and said status of the conversations to said plurality of agents.

13. The method of claim 12, wherein said plurality of identities are accepted by said second communication management module.

14. The method of claim 12, wherein said recorded conversations and said status of the conversations are stored in said database.

15. The method of claim 12, wherein said recorded conversations are obfuscated from the operating systems' communications history by said second communication management module.

16. A computer program product comprising a non-transitory computer-readable medium having a computer-readable program code embodied therein to be executed by one or more processors, said program code including instructions to:
receive communication requests associated with a plurality of identities from communication devices by a first communication management module, whereby said first communication management module is configured to send said plurality of identities to a second communication management module;
store said plurality of identities in a database by said second communication management module;
search said plurality of identities from said database and retrieve the data associated with said plurality of identities by said second communication management module;
mask said retrieved data by a virtual data and display said virtual data on said second communication management module and said first communication management module;
establish communication between a plurality of agents and a plurality of users by said virtual data and record conversations for said established communication by said second communication management module;
analyze said recorded conversations and determine said status of the conversations by said second communication management module; and
send said analyzed conversations and said status of the conversations to said plurality of agents.

17. The computer program product of claim 16, wherein said first communication management module comprises a request receiving module configured to receive said communication requests associated with said plurality of identities.

18. The computer program product of claim 16, wherein said second communication management module comprises a data search module configured to search the data associated with said plurality of identities in said database.

19. The computer program product of claim 16, wherein said second communication management module comprises a data retrieving module configured to retrieve the data.

20. The computer program product of claim 16, wherein said second communication management module comprises a data masking module configured to mask said retrieved data by said virtual data.

21. The computer program product of claim 16, wherein said second communication management module comprises a communication establishing module configured to establish said communication between said plurality of users and said plurality of agents using said virtual data.
